(19) United States
(12) Patent Application Publication
(10) Pub. No.: US 2013/0007243 A1
(43) Pub. Date: Jan. 3, 2013

(54) INFORMATION PROCESSING APPARATUS, METHOD OF PROCESSING INFORMATION AND STORAGE MEDIUM

(76) Inventor: Mikio Ohmori, Ome-shi (JP)

(21) Appl. No.: 13/414,396

(22) Filed: Mar. 7, 2012

(30) Foreign Application Priority Data
Jun. 30, 2011 (JP) 2011-146326

(51) Int. Cl. G06F 15/173; H04W 8/00

(52) U.S. Cl. 709/223

(57) ABSTRACT

According to one embodiment, an information processing apparatus includes an image management module, an image delivery module, a setting module and a management number processing module. The image delivery module delivers image data managed by the image management module to one or more other information processing apparatuses. The management number processing module informs the one or more other information processing apparatuses of unique management number set by the setting module to update the management number in the delivered image data to the informed management number.

### CROSS-REFERENCE TO RELATED APPLICATIONS

This application is based upon and claims the benefit of priority from prior Japanese Patent Application No. 2011-146326, filed Jun. 30, 2011, the entire contents of which are incorporated herein by reference.

### FIELD

Embodiments described herein relate generally to information processing techniques suitable for a network system which manages, for example, a plurality of clients with a server.

### BACKGROUND

In recent years, the push for information technology in business processes has been advancing in many companies. In such companies, employees do their work using, for example, personal computers (PCs) loaned by the companies. In addition, to share resources including data by connecting the PCs to one another, the installation of a local area network (LAN) has been widely applied in offices.

In parallel with this, the following problem has occasionally arisen: classified company secretes are leaked via PCs used by employees in business. Because of this, various mechanisms for enhancing the security of PCs used for business in offices have been proposed.

For example, a thin client is a computer which includes only a communication device, a user-interface keyboard and a display device in addition to a central processing unit (CPU) and a main memory. Various programs including an operating system and data are managed by a server (thin-client server) connected via a network. That is, since data is not held by the thin client used by the user, the leakage of information can be prevented and the enhancement of security can be realized.

Recently, companies that have installed a LAN in offices and loaned PCs to their employees for business purposes have begun to introduce a system that monitors the operating state of PCs loaned to their employees by a server. Such a system is called a system management system (SMS). When the SMS has been introduced, SMS software installed in each client gathers information indicating the operating state of each client and transmits the gathered information to the server. Using the information gathered in the server, the administrator can check how each client has been used. The SMS allocates a management number to each client, distinguishing each client on the server. In other words, a management number allocated to each client is attached to items of information gathered and transmitted to the server by the SMS software installed in each client.

A thin client operates on the basis of software resources (image data after various programs including an operating system have been installed, for example) managed by the server. Therefore, all the thin clients under the control of the same server are in the same operating environment, preventing a unique management number from being allocated to each client. Accordingly, the SMS cannot be introduced.

Furthermore, to introduce the SMS, preparing image data for each thin client to allocate a unique management number to each thin client, specifically, customizing an SMS software part in image data for each client and holding the customized part in each server, leads to a substantial cost rise and therefore is not feasible.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing a configuration of a computer system according to an embodiment.

FIG. 2 is an exemplary conceptual diagram showing a general outline of centralized control of clients performed by a management server in the computer system of the embodiment.

FIG. 3 is an exemplary diagram showing a software configuration of a management server in the computer system of the embodiment.

FIG. 4 is an exemplary diagram showing a software configuration of a client in the computer system of the embodiment.

FIG. 5 is an exemplary diagram showing a flow of processing when the management server delivers image data to a client for the first time in the computer system of the embodiment.

FIG. 6 is an exemplary diagram showing a table that lists items of information managed by the management server in the computer system of the embodiment.

FIG. 7 is an exemplary diagram showing a top screen in a setting screen group presented by the management server in the computer system of the embodiment.

FIG. 8 is an exemplary diagram showing a client edit screen in the setting screen group presented by the management server in the computer system of the embodiment.

FIG. 9 is an exemplary diagram showing a flow of processing when the management server redelivers image data to a client (or when the management server delivers differential data to update image data) in the computer system of the embodiment.

### DETAILED DESCRIPTION

Various embodiments will be described hereinafter with reference to the accompanying drawings.

In general, according to one embodiment, an information processing apparatus, which manages one or more other information processing apparatuses connected via a network, includes an image management module, an image delivery module, a setting module and a management number processing module. The image management module is configured to manage image data obtained by executing installation of various programs including an operating system and a system management program. The operating system is caused to run on the one or more other information processing apparatus. The system management program gathers information indicating an operating state of the one or more other information processing apparatuses and transmitting the gathered information to the information processing apparatus. The image delivery module is configured to deliver the image data managed by the image management module to the one or more other information processing apparatuses. The setting module is configured to set a unique management number in each of the one or more other information processing apparatuses. The management number processing module is configured to inform the one or more other information processing apparatuses of the management number set by the setting module to cause the one or more other information processing apparatuses to update the management number held by the system management program in the image data delivered by the image delivery module to the informed management number.

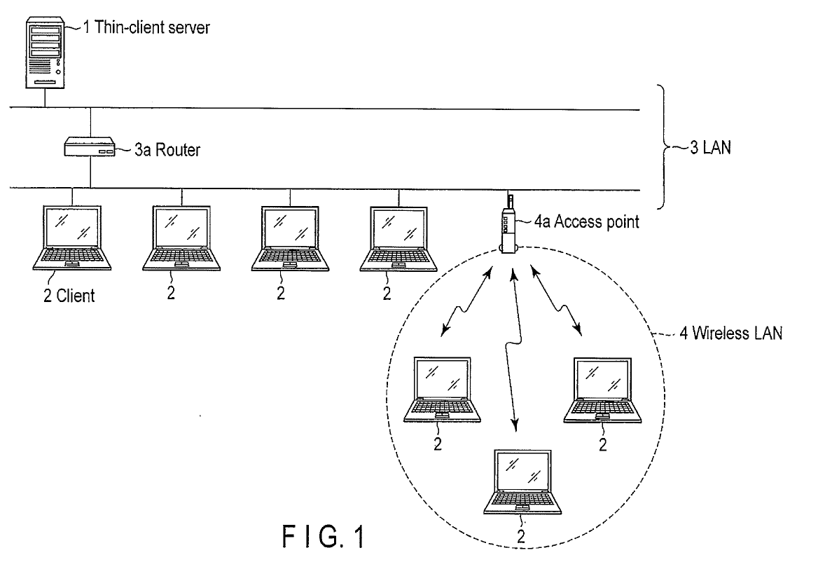

FIG. 1 is an exemplary diagram showing a configuration of a computer system according to an embodiment. The computer system is, for example, a network system a company builds for business purposes. In the computer system, each employee (user) does work using a client 2. Each client 2, which is connected to a thin-client server 1 via a LAN 3 built across a plurality of floors by, for example, a router 3a, operates using image data delivered from the thin-client server 1.

The image data is generated by, for example, constructing a virtual machine on the thin-client server 1, and installing an operating system caused to operate on the client 2 and various business-oriented application programs that operate under the control of the operating system on this virtual machine. The virtual machine is a virtual hardware environment for running the various programs including the operating system. Therefore, all the clients 2 that operate using image data delivered from the thin-client server 1 are set in the same operating environment. In other words, the operating environments of the clients 2 are managed uniformly in a centralized manner. Therefore, the user can do the same job even if using any client 2. Hereinafter, image data for an operating environment of the client 2 generated by the thin-client server 1 may be referred to as virtual image, and an operating environment constructed on the client 2 using the image data may be referred to as a virtual desktop.

In addition, application programs used in departments differ partially from one department to another, the thin-client server 1 generates, if needed, differential data for customizing basic image data applied company-wide for use in each department. When image data is delivered to a client 2 belonging to a certain department, the thin-client server 1 customizes image data on the basis of differential data for the department as needed and delivers the resulting data.

The client 2 applied to the computer system, which is, for example, a notebook computer, differs from an ordinary thin client and includes a storage device, such as a hard disk drive (HDD). The client 2 stores image data delivered from the thin-client server 1 into a storage device, such as an HDD, and basically uses image data stored in the storage device. In addition, the thin-client server 1 can manage not only a client 2 connected to the LAN 3 by wire but also a client 2 on a wireless LAN 4 connected to the LAN 3 via an access point 4a.

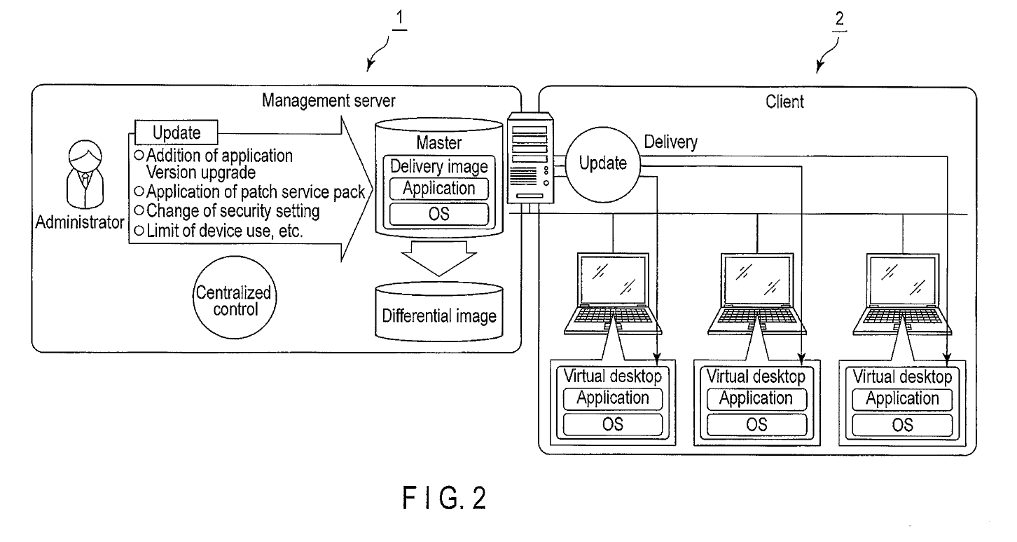

FIG. 2 is an exemplary conceptual diagram showing a general outline of centralized control of clients 2 performed by the thin-client server 1 in the computer system of the embodiment.

As described above, the thin-client server 1 generates and manages image data of various programs including an operating system running on the client 2 and delivers the image data to each client 2. Each client 2 operates using the image data delivered from the thin-client server 1. For example, when an application program has to be added or upgraded in version, the thin-client server 1 generates differential image, called a patch, for updating image data and delivers the differential image to each client 2. Each client 2 updates the image data using the differential image delivered from the thin-client server 1.

Here, consider a case where an SMS is introduced to monitor the operating state of each client 2 in the computer system of the embodiment where the individual clients 2 that receive the image data from the thin-client server 1 are set in the same operating environment.

As described above, the SMS needs a unique management number for each client 2. In the computer system that manages the operating environment of clients 2 uniformly in a centralized manner with the thin-client server 1, it is desirable that SMS software running on the client 2 should be included in image data delivered from the thin-client server 1. However, at that time, the SMS software delivered to each client 2 has the same management number as an initial value. When a management number to be given to the SMS software is set individually on each client side (after image data has been received), if the update of the image data has occurred, each client 2 requires the work of resetting a management number, which impairs user-friendliness.

Therefore, firstly, the computer system of the embodiment enables a unique management number to be set for each client that operates using the same image data delivered from the thin-client server 1. Secondly, the computer system enables the client to be used continuously without losing the set management number even if image data has been delivered again (or even if updating is performed using differential data). Hereinafter, this will be explained in detail.

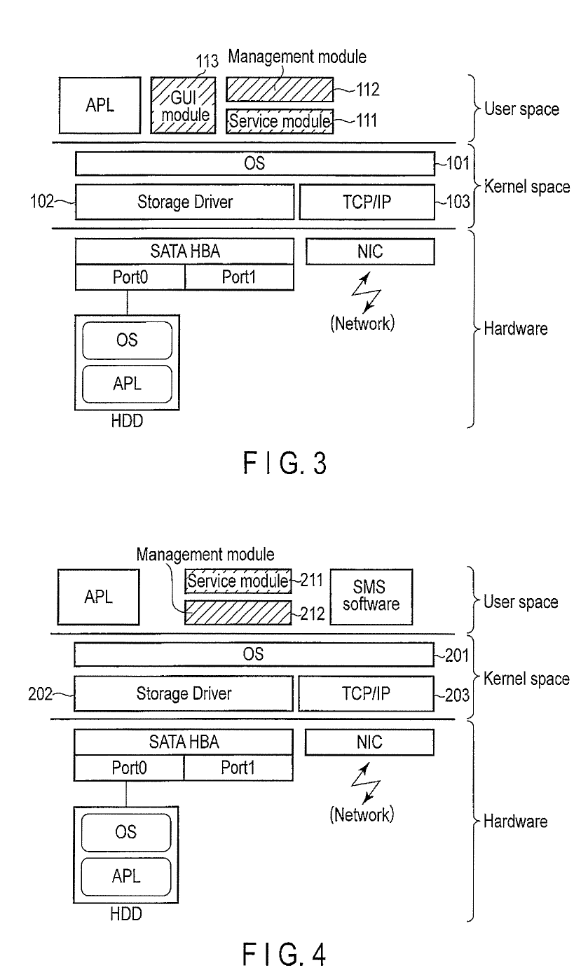

FIG. 3 is an exemplary diagram showing a software configuration of the thin-client server 1. FIG. 4 is an exemplary diagram showing a software configuration of the client 2.

As shown in FIG. 3, there are provided not only basic software including an operating system 101 and a device driver 102 but also a service module 111, a management module 112, and a graphical user interface (GUI) module 113.

The service module 111 services the generation and management of image data to be delivered to the client 2 and the delivery of image data to the client 2. The management of image data by the service module 111 includes the generation of differential image to update image data.

The management module 112 services the management of the management numbers of the individual clients 2 (to be given to the SMS software running on the individual clients 2). The service module 111 informs the clients 2 of the management numbers managed by the management module 112. The GUI module 113 services the exchange of various items of information, including management numbers, between the user (administrator) and the management module 114.

The thin-client server 1 includes a network function (103) conforming to Transmission Control Protocol/Internet Protocol (TCP/IP) to communicate with the client 2.

In the client 2, there are provided a service module 211 and a management module 212 as shown in FIG. 4. It goes without saying that basic software, including an operating system 201 and a device driver 202, is provided also in the client 2. In addition, the client 2 also includes a network function (203) conforming to TCP/IP to communicate with the thin-client server 1.

The service module 211 services control to cause the client 2 to operate on the basis of image data delivered from the thin-client server 1. The service module 211, which includes the function of constructing a virtual machine on the client 2, causes various programs including an operating system included in image data delivered from the thin-client server 1 to run on the virtual machine. The service module 211 displays image data for a display screen output by various programs running on the virtual machine on a display device and transmits input data from an input device to various programs running on the virtual machine.

The function of the service module 211 realizes the turning of the client 2, a PC with a storage device, such as an HDD, into a thin client. The service module 211 also executes acquisition of image data from the thin-client server 1 and updating of image data using differential image delivered from the thin-client server 1. In addition, the service module 211 includes the function of acquiring setting information (e.g., the media access control [MAC] address) of a network interface card (NIC) installed in the client 2.

The management module 212 services the management of management numbers held by SMS software running on the client 2. The SMS software is delivered as one of the various programs included in image data from the thin-client server 1 to each client 2. Therefore, a management number with the same value as that of another client 2 has been given as an initial value to the SMS software. Therefore, the management module 212 performs the process of updating the management numbers held by the SMS software to the management numbers notified by the thin-client server 1. The function of the management module 212 realizes the introduction of SMS in the computer system where the client 2 has been turned into a thin client (because management numbers to be given to the SMS software can be made different from one client 2 to another).

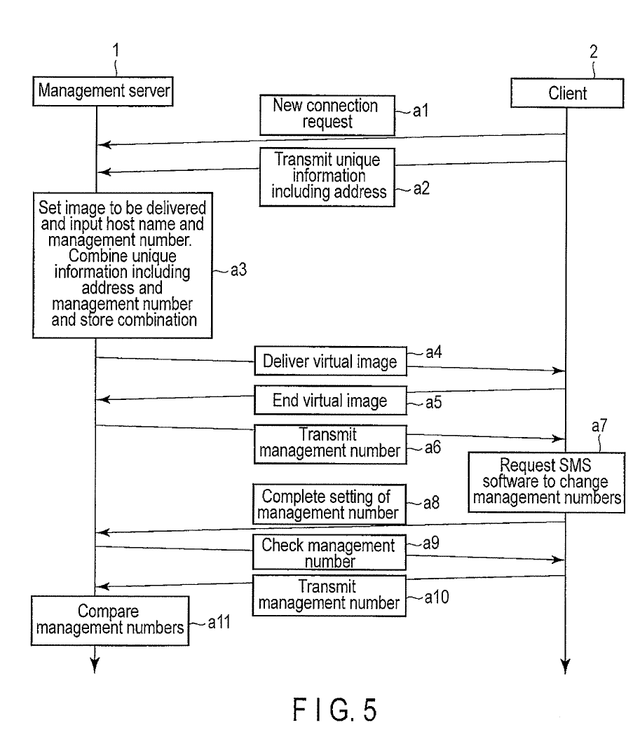

With reference to FIG. 5, the flow of processing when the management server 1 delivers image data to a client 2 for the first time in the computer system of the embodiment will be explained.

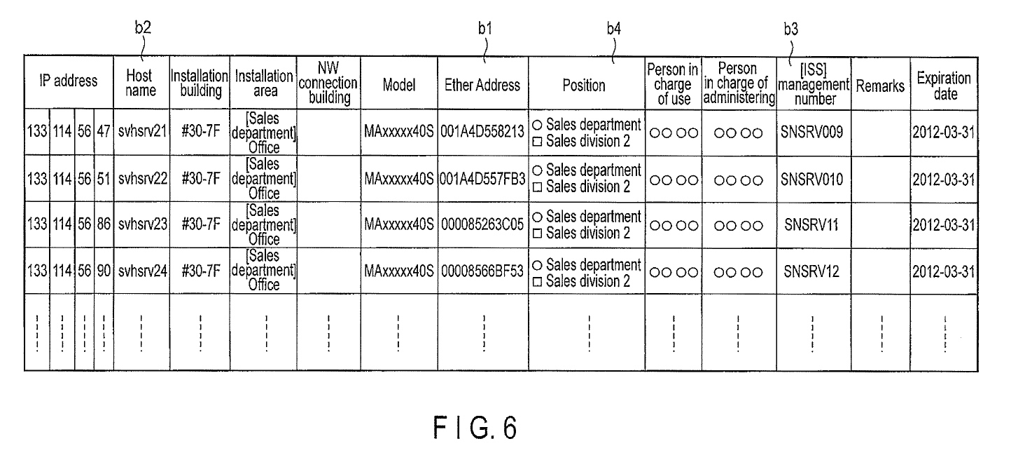

For example, to increase the number of clients 2 in the computer system, a client 2 is newly connected to the LAN 3, the network function (203) of the client 2 transmits a new connection request to the thin-client server 1 (a1 in FIG. 5). At this time, the network function (203) transmits unique information on the client 2, for example, setting information (e.g., the MAC address) of the NIC installed in the client 2 (a2 in FIG. 5). Unique information on the client 2 is managed by the management module 112 of the thin-client server 1. FIG. 6 an exemplary diagram showing a table that lists items of information managed by the management module 112 of the thin-client server 1.

“Ether Address” (b1) in FIG. 6 is unique information on the client 2 sent from the client 2. In addition to this, the management module 112 of the thin-client server 1 manages “Host name” (b2), “[ISS] management number” (b3), “Position” (b4), and others for each of the clients 2. “Host name” (b2) is a so-called mnemonic that helps the administrator to recognize a client 2. “[ISS] management number” (b3) is a management number to be allocated to SMS software running on a client 2. “Position” (b4) is information used by the service module 111 of the thin-client server 1 to determine image data to be delivered to a client 2. The GUI module 113 provides a user interface function that enables the administrator to set “Host name” (b2) and “[ISS] management number” (b3) shown in FIG. 6.

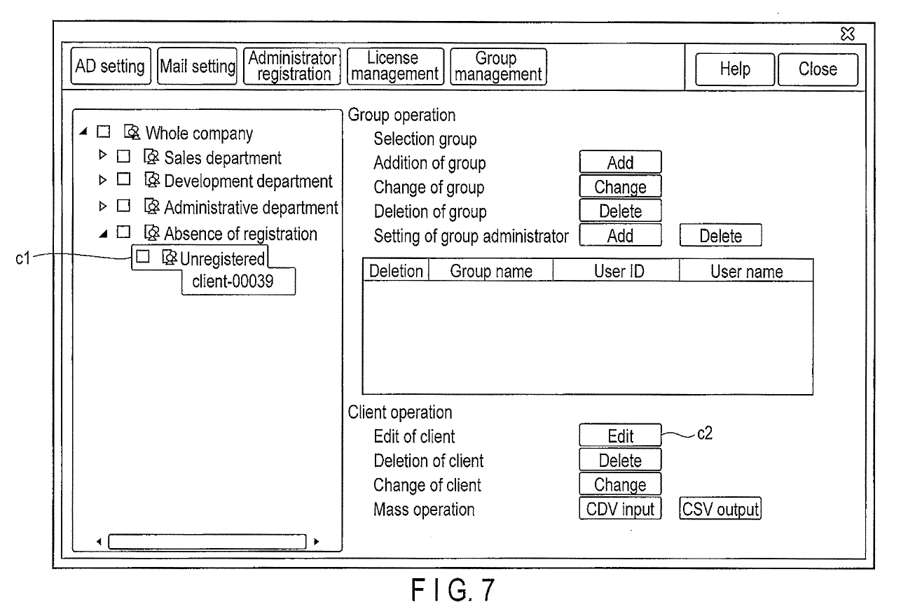

FIG. 7 is an exemplary diagram showing a top screen in a setting screen group the GUI module 113 of the thin-client server 1 presents to the administer of the computer system.

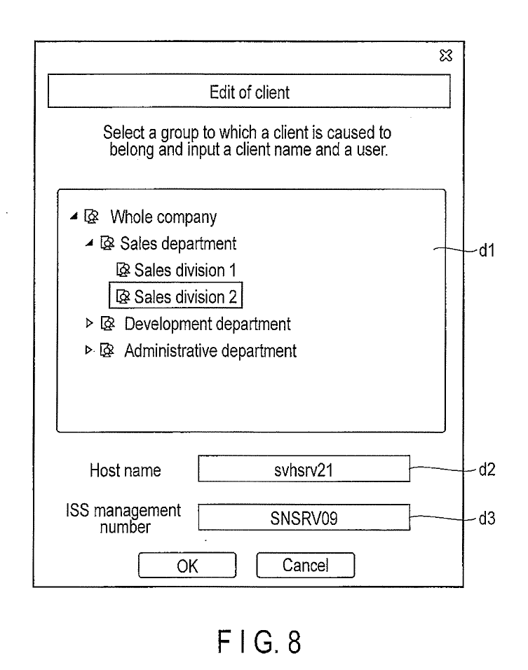

A client 2 newly connected to the LAN 3 is displayed as “unregistered client” (c1 in FIG. 7) on the top screen. The administrator selects the “unregistered client” and operates “Edit” button (c2 in FIG. 7) to move to a client edit screen. Then, the GUI module 113 of the thin-client server 1 displays a client edit screen shown in FIG. 8.

As shown in FIG. 8, on the client edit screen, there are provided a field (d1 in FIG. 8) for setting “Position” for the “unregistered client” selected on the top screen of FIG. 7, a field (d2 in FIG. 8) for setting “Host name,” and a field (d3 in FIG. 8) for setting “[ISS] management number.” Setting performed on the client edit screen determines image data to be delivered to the client 2 and causes various items of information on the client 2 (shown in FIG. 6) to be stored (a3 in FIG. 5).

Next, the service module 111 of the thin-client server 1 delivers image data intended for the client 2 to the client 2 (a4 in FIG. 5). In the client 2, the service module 211 receives the image data and stores it in the storage device and informs the thin-client server 1 that the image data has been received and stored (a5 in FIG. 5).

Then, the service module 111 of the thin-client server 1 transmits the management number of the client 2 managed by the management module 112 to the client 2 (a6 in FIG. 5). The service module 211 of the client 2 passes the notified management number to the management module 212. Then, the management module 212 requests the SMS software running on the client 2 to update the management number held as the initial value to the management number received from the service module 211 (a7 in FIG. 5). After the SMS software has updated the management number, the management module 212 informs the service module 211 of the completion of the update and the service module 211 reports the completion of setting the management number to the thin-client server 1 (a8 in FIG. 5).

Having received the report, the service module 111 of the thin-client server 1 requests the client 2 to transmit the management number set in the SMS software to check whether the setting has been done reliably (a9 in FIG. 5). Having received the request, the service module 211 of the client 2 causes the management module 212 to acquire the management number from the SMS software and transmits the number to the thin-client server 1 (a10 in FIG. 5). The service module 111 of the thin-client server 1 compares the management number transmitted from the client 2 with the management number of the client 2 managed by the management module 112 to check whether the management number in the SMS software has been set correctly (all in FIG. 5).

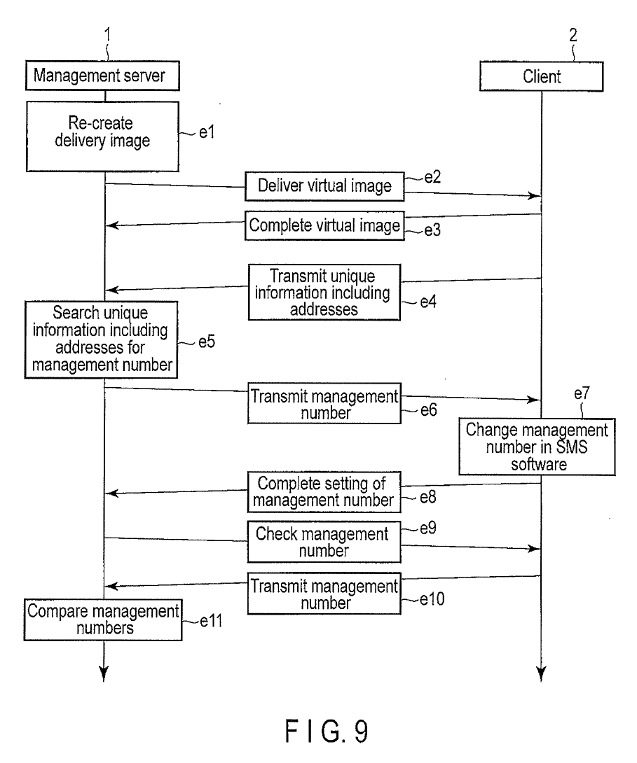

Next, the flow of processing when the thin-client server 1 delivers image data again to the client 2 (or the thin-client server 1 delivers differential data to update image data) in the computer system of the embodiment will be explained with reference to FIG. 9.

For example, when a business-oriented application program is upgraded in version, the service module 111 of the thin-client server 1 re-generates image data including the application program (e1 in FIG. 9). More specifically, the service module 111 generates differential data to upgrade the image data. The service module 111 of the thin-client server 1 delivers the re-generated image data to the client 2 (e2 in FIG. 9).

In the client 2 that has received the redelivered image data, the service module 211 updates the image data on the client 2 and informs the thin-client server 1 of the completion of the update (e3 in FIG. 9). When the image data has been updated, the management number set in the SMS software might have been returned to the initial value. Therefore, the computer system performs the following process when image data has been redelivered.

First, the service module 211 of the client 2 informs the thin-client server 1 of the update of image data, then acquires setting information (e.g., the MAC address) on the NIC installed in the client 2, and transmits the information as unique information of the client 2 to the thin-client server 1 (e4 in FIG. 9).

As described above, the management module 112 of the thin-client server 1 manages various items of information shown in FIG. 6 for each of the clients 2. The service module 111 of the thin-client server 1 passes the unique information sent from the client 2 to the management module 112 and causes the management module 112 to search for the management number of the client 2 using the unique information as a search key (e5 in FIG. 9). Then, the service module 111 transmits the management number returned from the management module 112 to the client 2 (e6 in FIG. 9).

The flow of processing after the management number has been transmitted from the thin-client server 1 to the client 2 is the same as that of the processing when image data is newly delivered (a7 to all in FIG. 5) explained with reference to FIG. 5. Specifically, the management module 212 of the client 2 requests the SMS software running on the client 2 to update the held management number to the management number received from the service module 111 (e7 in FIG. 9). The service module 211 of the client 2 informs the thin-client server 1 of the completion of setting the management number (e8 in FIG. 9).

The service module 111 of the thin-client server 1 requests the client 2 to transmit the management number set in the SMS software to check whether the setting has been done reliably (e9 in FIG. 9). Having received the request, the service module 211 of the client 2 causes the management module 212 to acquire the management number from the SMS software and transmits the number to the thin-client server 1 (e10 in FIG. 9). Then, the service module 111 of the thin-client server 1 compares the management number transmitted from the client 2 with the management number of the client 2 managed by the management module 112 to check whether the management number in the SMS software has been set correctly (e10 in FIG. 9).

This causes the previous management numbers to be held in the SMS software without the work of reallocating management numbers to the SMS software for all the clients whose image data has been updated.

As described above, with the computer system of the embodiment, firstly, a unique management number can be set in each client that operates using the same image data delivered from the thin-client server 1. Secondly, even if image data has been redelivered (or even if updating has been done using differential data), management numbers already set can be used continuously without losing the numbers. That is, a unique management number can be set for each client that operates using the same image data, which enables the SMS to manage the individual clients that operate using the same image data.

Since the operation control of the embodiment can be realized by software (programs), the software can be installed in an ordinary computer via a computer-readable storage medium in which the software has been stored and be executed on the computer, thereby realizing the same effect as that of the embodiment easily.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus which manages one or more other information processing apparatuses connected via a network, the information processing apparatus comprising:
an image management module configured to manage image data obtained by executing installation of various programs comprising an operating system and a system management program, the operating system being caused to run on the one or more other information processing apparatus, the system management program gathering information indicating an operating state of the one or more other information processing apparatuses and transmitting the gathered information to the information processing apparatus;
an image delivery module configured to deliver the image data managed by the image management module to the one or more other information processing apparatuses;
a setting module configured to set a unique management number in each of the one or more other information processing apparatuses; and
a management number processing module configured to inform the one or more other information processing apparatuses of the management number set by the setting module to cause the one or more other information processing apparatuses to update the management number held by the system management program in the image data delivered by the image delivery module to the informed management number.

2. The apparatus of claim 1, further comprising a client management module configured to acquire unique information allocated uniquely to each of the one or more other information processing apparatuses and to manage the acquired unique information and the management number set by the setting module in such a manner that the unique information and the management number correspond to each other,
wherein the management number processing module is configured to reinform the one or more other information processing apparatuses of the management number based on the unique information and the management numbers managed by the client management module to cause the one or more other information processing apparatuses to update the management number held by the system management program in the image data redelivered by the image delivery module to the reinformed management number, when the image delivery module redelivers the image data to the one of more other information processing apparatuses.

3. The apparatus of claim 2, wherein the image delivery module is configured to redeliver updated image data to the one or more other information processing apparatuses by delivering differential data for updating the image data to be updated to the updated image data to the one or more other information processing apparatuses.

4. The apparatus of claim 1, further comprising a management number check module configured to acquire the management number held by the system management program running on the one or more other information processing apparatuses and to check whether the acquired management number corresponds with the management number set by the setting module.

5. The apparatus of claim 2, wherein the unique information managed by the client management module comprises a media access control (MAC) address.

6. A method of processing information for a computer system where a first computer and a second computer are connected via a network, the method comprising:
managing, by the first computer, image data obtained by executing installation of the various programs comprising an operating system and a system management program, the operating system being caused to run on the second computer, the system management program gathering information indicating an operating state of the second computer and transmitting the gathered information to the first computer;
delivering, by the first computer, the managed image data to the second computer;
setting, by the first computer, a unique management number in the second computer;
informing, by the first computer, the second computer of the set management number;
storing, by the second computer, the image data delivered from the first computer into a storage device; and
updating, by the second computer, the management number held by the system management program in the image data stored in the storage device to the management number informed from the first computer.

7. The method of claim 6, further comprising:
acquiring, by the first computer, unique information allocated uniquely to the second computer and managing the acquired unique information and the management number in such a manner that the unique information and the management number correspond to each other;
reinforming, by the first computer, the second computer of the management number based on the unique information and the management number, when the image data is redelivered to the second computer,
updating, by the second computer, the image data stored in the storage device to the updated image data redelivered from the first computer; and
updating, by the second computer, the management number held by the system management program in the updated image data stored in the storage device to the management number reinformed from the first computer.

8. The method of claim 7, wherein the redelivering, by the first computer, the second computer of the management number comprises delivering differential data for updating the image data to be updated to the updated image data to the second computer.

9. The method of claim 6, further comprising acquiring, by the first computer, the management number held by the system management program running on the second computer and checking whether the acquired management number corresponds with the management number.

10. A computer-readable, non-transitory storage medium having stored thereon a computer program which is executable by a first computer and a second computer connected via a network,
the computer program controlling the first computer to function as:
an image management module configured to manage image data obtained by executing installation of various programs comprising an operating system and a system management program, the operating system being caused to run on the second computer, the system management program gathering information indicating an operating state of the second computer and transmitting the gathered information to the first computer;
an image delivery module configured to deliver the image data managed by the image management module to the second computer;
a setting module configured to set a unique management number in the second computer; and
a management number informing module configured to inform the second computer of the management number set by the setting module, and
the computer program controlling the second computer to function as:
an image storage module configured to store the image data delivered from the first computer into a storage device; and
a management number updating module configured to update the management number held by the system management program in the image data stored in the storage device by the image storage module to the management number informed from the first computer.

11. The medium of claim 10, wherein:
the computer program further controls the first computer to function as a client management module configured to acquire unique information allocated uniquely to the second computer and to manage the acquired unique information and the management number in such a manner that the unique information and the management number correspond to each other;
the management number informing module of the first computer is configured to reinform the second computer of the management number based on the unique information and the management number managed by the client management module, when the image delivery module redelivers the image data to the second computer;
the image storage module of the second computer is configured to update the image data stored in the storage device to the updated image data redelivered from the first computer; and
the management number updating module of the second computer is configured to update the management number held by the system management program in the updated image data stored in the storage device to the management number reinformed from the first computer.

12. The medium of claim 11, wherein the image delivery module of the first computer is configured to redeliver updated image data to the second computer by delivering differential data for updating the image data to be updated to the updated image data to the second computer.

13. The medium of claim 10, wherein the computer program further controls the first computer to function as a management number check module configured to acquire the management number held by the system management program running on the second computer and to check whether the acquired management number corresponds with the management number set by the setting module.
